(19) United States
(12) Patent Application Publication
(10) Pub. No.: US 2002/0100993 A1
(43) Pub. Date: Aug. 1, 2002

(54) Method of making a golf ball

(76) Inventors: Hiroaki Tanaka, Kobe-shi (JP); Hideki Sano, Kobe-shi (JP)

Correspondence Address: BIRCH STEWART KOLASCH & BIRCH, PO BOX 747, FALLS CHURCH, VA, 22040-0747, US

(21) Appl. No.: 09/987,470

(22) Filed: Nov. 14, 2001

(30) Foreign Application Priority Data
Nov. 14, 2000 (JP) 346639/2000

(51) Int. Cl. B28B 11/04; B28B 11/22; B29C 67/00

(52) U.S. Cl. 264/80; 264/132; 264/162; 264/233

(57) ABSTRACT

The present invention provides a method of making a coated golf ball having good adhesion of a paint, good uniformity of a thickness of paint layer, excellent safety and excellent productivity. The present invention relates to a method of making a coated golf ball comprising

a golf ball body, of which the surface portion is formed from resin composition or rubber composition, and

a paint layer formed on the golf ball body,

wherein the paint is coated within 72 hours after molding the golf ball body in a mold.

### FIELD OF THE INVENTION

The present invention relates to a method of making a coated golf ball. More particularly, it relates to a method of making a coated golf ball having good adhesion of a paint, good uniformity of a thickness of paint layer, excellent safety and excellent productivity.

### BACKGROUND OF THE INVENTION

There are many types of golf balls, such as solid golf balls (e.g. one-piece solid golf balls, two-piece solid golf balls, three-piece solid golf balls and the like) and thread-wound golf balls, and they are all supplied into the market in the form of a coated golf ball having a paint layer provided on the surface of the golf ball body. The paint layer is provided for the protection of the surface of the golf ball body or a marking provided thereon, for maintaining a white glossy appearance for a long period of time, or for improving abrasion resistance to sand and the like when hit from the bunker.

It is required for the paint to have good adhesion to the golf ball body, and have good uniformity of a thickness of the paint layer in order to stabilize flight performance of the resulting golf ball. In conventional golf balls, it has suggested to uniformize the thickness of the paint layer by coating the paint into a multi-layer (Japanese Patent Kokai Publication No. 322961/1996), and to improve the adhesion of the paint by performing a pretreatment using aqueous solution containing active chlorine and then coating the paint into a single layer (Japanese Patent Kokai Publication No. 317459/1993). In the coated golf balls, the paint has been generally coated over 72 hours after molding the golf ball body. This is for the following reasons. The paint is not coated until shrinkage after molding under applied heat of the golf ball consisted of resin composition and rubber composition is stable and dimensional stabilization is obtained in order to reduce the stress applied to the paint layer as small as possible.

However, the conventional coated golf ball has the following problems. When the paint is coated into multi-layer, the number of steps of coating increases, and the productivity is degraded. In addition, separation between the paint layers occurs. The strength reduction between the paint layers occurs about one month after coating the paint. It is difficult to obtain uniformity of wettability of the surface of the golf ball body when performing the pretreatment using aqueous solution containing active chlorine as a pretreatment for coating a paint. The adhesion of the paint layer to the golf ball body is degraded about one month after coating. However, since a toxic substance is used in the pretreatment using aqueous solution containing active chlorine, there are problem with regard to safety and influence to environment. In addition, since the pretreatment is batch treatment, it is required to use large-scale apparatus. In addition, since the golf ball body is left to stand for more than 72 hours, it is not preferable for a lead time to be long.

### OBJECTS OF THE INVENTION

A main object of the present invention is to provide a coated golf ball having good adhesion of a paint, good uniformity of a thickness of paint layer, excellent productivity and excellent safety.

According to the present invention, the object described above has been accomplished by coating paint within 72 hours after molding the golf ball body in a mold to form a paint layer on the golf ball body, thereby providing a coated golf ball having good adhesion of a paint, good uniformity of a thickness of paint layer, excellent productivity and excellent safety.

### SUMMARY OF THE INVENTION

The present invention provides a method of making a coated golf ball comprising

a golf ball body, of which the surface portion is formed from resin composition or rubber composition, and

a paint layer formed on the golf ball body,

wherein the paint is coated within 72 hours after molding the golf ball body in a mold.

In order to put the present invention into a more suitable practical application, it is desired that

further comprising a step of performing a pretreatment of the surface of the golf ball body for coating a paint by at least one treatment selected from the group consisting of grinding or blasting treatment, washing and flaming treatment, before coating the paint; and

the step of performing a pretreatment of the surface of the golf ball body is performed by the grinding or blasting treatment, followed by the washing treatment.

In order to solve the problem of the separation between the paint layers in the conventional coated golf ball as described above, the paint layer has single-layered structure in the coated golf ball of the present invention. The present inventors studied the time until the paint is coated after molding the golf ball body, and, as a result, they found that residual stress is reduced by coating the paint within 72 hours after molding, because the paint itself also shrinks.

In the method of making the coated golf ball of the present invention, since the pretreatment of the surface of the golf ball body for coating a paint is performed by at least one treatment selected from the group consisting of grinding or blasting treatment, washing and flaming treatment, it has excellent safety because no toxic substance is used, it is not required to use large-scale apparatus, and a change in the adhesion between the paint and the golf ball body with time is small.

The term “golf ball body” as used herein refers to a golf ball itself before it is coated with paint, of which the surface portion has many dimples. The term “coated golf ball” as used herein refers to a golf ball having a paint layer obtained by coating a paint on the golf ball body.

### DETAILED DESCRIPTION OF THE INVENTION

The golf ball of the present invention may be either solid golf balls, such as a one-piece golf ball, two-piece golf ball, and multi-piece golf ball represented by a three-piece golf ball, or thread wound golf balls.

In case of the solid golf ball, one-piece golf ball or a core used for solid golf (solid core) may be the same one that has been conventionally used, and may be obtained by mixing a rubber composition using a mixer such as a mixing roll, and then vulcanizing and press-molding under applied heat the rubber composition in a mold into a spherical form. The rubber composition comprises

10 to 60 parts by weight of a vulcanizing agent (crosslinking agent), for example, α,β-unsaturated carboxylic acid (such as acrylic acid, methacrylic acid, etc.) or mono or divalent metal salts, such as zinc or magnesium salts thereof, or a functional monomer such as trimethylolpropane trimethacrylate, or a combination thereof;

0.5 to 5 parts by weight of co-crosslinking initiator such as organic peroxides;

10 to 30 parts by weight of filler such as zinc oxide, barium sulfate and the like; and

optionally antioxidant,

based on 100 parts by weight of a base rubber such as polybutadiene. The vulcanization may be conducted, for example, by press molding in a mold at 130 to 240° C. and 2.9 to 11.8 MPa for 15 to 60 minutes. It is preferable for the surface of the resulting core to be buffed to improve the adhesion to the cover layer formed on the core. The solid core may have single-layered structure or multi-layered structure which has two or more layers.

The core for thread wound golf ball (thread wound core), which may be also the same one that has been conventionally used, comprises a center and a thread rubber layer formed by winding thread rubber in a stretched state around the center, wherein the center may be either liquid center or solid center formed from rubber composition. The thread rubber can be of the same kind, which has been conventionally used for the thread rubber layer of the thread wound golf ball. For example, the thread rubber can be obtained by vulcanizing a rubber composition prepared by formulating sulfur, a vulcanization aid, a vulcanization accelerator, an antioxidant and the like to a natural rubber or a blend rubber of the natural rubber and a synthetic polyisoprene. A thread-wound core can be produced by drawing the thread rubber about 1000% and winding it over the center. However, such solid and thread-wound cores are given by way of illustrative examples only, and the invention shall not be limited thereto.

The cover is then covered on the core. In the golf ball of the present invention, the cover may be formed from thermoplastic resin such as ionomer resin, balata or hard rubber and the like, which has been conventionally used for the cover of the golf ball. Preferred is ionomer resin, because the ionomer resin contains free carboxyl group, and the resulting golf ball having ionomer cover has excellent adhesion to the paint layer.

In the coated golf ball, it is required to coat a paint within 72 hours, preferably 48 hours, more preferably 24 hours after molding the golf ball body in a mold. When the time from molding the golf ball body to coating the paint is short, the adhesion of the paint is excellent and the productivity is improved.

In the coated golf ball of the present invention, the surface of the golf ball body is pretreated for coating a paint, and the paint is then coated thereon. The pretreatment is performed preferably by at least one treatment selected from the group consisting of grinding or blasting treatment, washing and flaming treatment, and more preferably by the grinding or blasting treatment, followed by the washing.

The grinding treatment is a method of grinding the surface of the golf ball body by using abrasive stone or abrasive cloth. Particularly preferred is barrel grinding treatment, because the productivity is excellent and it is possible to uniformly grind throughout the surface of the golf ball body, or it is always possible to uniformly grind between the golf balls. The barrel grinding treatment is a method of grinding by rotating a barrel apparatus, in which the golf ball body and abrasive stone are placed.

The blasting treatment is a method of roughening the surface of the golf ball body by blowing nonmetal particle such as silica sand or metal particle thereto at high speed. Preferred is the blasting treatment using the nonmetal particle, particularly silica sand, because it is always possible to uniformly treat throughout the surface of the golf ball body, or between the golf balls.

The washing treatment is a method of removing stain, release agent and the like on the surface of the golf ball body after molding, by which the adhesion to the paint layer is degraded, and is performed by using water, organic solvent, chemical agent and the like.

The flaming treatment is a method of oxidizing the surface of the golf ball body by blowing flame thereto. The treatment has problems that treatment apparatus is expensive and it is required to set the treatment condition in detail such that the material of the surface of the golf ball body is not deteriorated. Therefore, the uniformity of the surface treatment is easy to degrade.

When the grinding or blasting treatment is performed among the above treatments, resin swarf remains on the surface of the golf ball body. Therefore, it is preferable to perform the washing treatment after the grinding or blasting treatment in order to remove the swarf from the surface of the golf ball body. Preferred is the grinding treatment, because the treatment apparatus is simple and available at low cost; it is possible to treat in large quantities, and the productivity is excellent; and it is always possible to uniformly treat throughout the surface of the golf ball body, or between the golf balls. Among the washing treatments, preferred is the washing treatment using water, because it is safety and easy to handle; and it is friendly to environment.

For the paint used in the present invention, urethane-based resin or epoxy-based resin can be used. Preferred is urethane-based paint. It is preferable to select the paint in consideration of the adhesion to the surface of the golf ball body. In a concrete way, the urethane-based paint, which includes active hydrogen containing compound such as polyester polyol, polyether polyol and the like as a main component and isocyanate compound as a curing agent, can be suitably used for the paint by reacting the main component with the curing agent. Examples of the isocyanate compounds include a modified 1,6-hexamethylene diisocyanate (burette-modified, trimethylolpropane-modified, trimerized), a modified tolylene diisocyanate and the like. The epoxy-based paint, which is formed from a main component comprising a compound having epoxy ring such as diglycidyl ether of bisphenol A and a curing agent mainly comprising polyamide, polyamine and the like, can be suitably used for the paint by reacting the main component with the curing agent.

The paint used in the present invention may contains various additives and diluents, in addition to the above mentioned components. Examples of the additives are ultraviolet absorbers, light stabilizers, sealing pigments, fluorescent agents, fluorescent brighteners and the like. The additives are present in an amount of 0.1 to 10% by weight, based on the solid content of the paint.

The fluorescent agent or fluorescent brightener may be the same one that has been conventionally used for golf balls, and includes 2,5-bis[5′-t-butylbenzoxazolyl(2)]thiophene (commercially available from Ciba Geigy AG under the trade name of “Ubitex OB”) and 7-(2h-naphthol-(1,2-d)-triazol-2-yl)-3-phenyl-kusline (commercially available from Sunzos Co. under the trade name of “Leucopure EMG”) as a preferable examples, and includes biazoline derivative (commercially available from Mobay Chemical Corporation under the trade name of “Phorwhite K-2002”), oxazoles (commercially available from Sumitomo Chemical Co., Ltd. under the trade name of “Whiteflure HCS, PCS and B) and Hostalux KCB (available from Hoechst Japan Co., Ltd.). It may be present in an amount of 0.005 to 1.0% by weight based on the solid content of the paint.

The diluent used for the paint includes water; alcohols, such as isopropyl alcohol; aromatic hydrocarbons, such as toluene; aliphatic hydrocarbons, such as hexane; esters, such as ethyl acetate; ketones, such as methyl ethyl ketone; and the like. The diluent may be present in an amount of 5 to 50% by weight based on the solid content of the paint.

The paint is coated on the golf ball body by any art-known method, such as air gun coating, electrostatic coating and the like.

### EXAMPLES

The following Examples and Comparative Examples further illustrate the present invention in detail but are not to be construed to limit the scope of the present invention.

(Golf ball I)

(i) The core composition having formulations shown in Table 1 was mixed, and press-molded at 160° C. for 20 minutes in a mold, which is composed of an upper mold and a lower mold having a semi-spherical cavity to obtain a spherical core having a diameter of 39.7 mm.

(ii) The materials having formulations shown in Table 2 were mixed using a kneading type twin-screw extruder to obtain pelletized cover compositions. The extrusion condition was,

a screw diameter of 45 mm,

a screw speed of 200 rpm, and

a screw L/D of 35.

The formulation materials were heated at 200 to 260° C. at the die position of the extruder.

The cover composition was covered on the resulting core by injection molding to form a cover layer and obtain a two-piece golf ball body. The mold for molding the cover, which is composed of an upper mold and a lower mold has a semi-spherical cavity having a diameter of 42.9 mm, and the cavity has dimples, of which one part is movable and also functions as hold pin. The core was placed in the cavity of the mold, and was held by putting out the hold pin. Cover resin under applied heat to 210° C. was injected in the mold, which was closed at clamping pressure of 80 t, for 0.3 seconds, and was cooled for 30 seconds to open the mold, followed by taking out the golf ball.

(Golf ball II)

The rubber composition having formulation shown in Table 1 was mixed, and press-molded at 160° C. for 20 minutes in a mold, which is composed of an upper mold and a lower mold having a semi-spherical cavity having dimples and a diameter of land portion of 42.9 mm to obtain a one-piece golf ball body.

TABLE 1

(parts by weight)

| | Core of golf | |
|---|---|---|
| Composition | ball I | Golf ball II |
| BR-01 *1 | 100 | 100 |
| Zinc acrylate | 30 | 30 |
| Zinc oxide | 22 | 30 |
| Percumyl D *2 | 1 | 1 |

*1: High-cis-polybutadiene, commercially available from JSR Co., Ltd. under the trade name of “BR-01” (Content of 1, 4-cis-polybutadiene: 97.1%)
*2: Dicumyl peroxide, commercially available from Nippon Oil & Fats Co., Ltd. under the trade name of “Percumyl D”

TABLE 2

| | Amount |
|---|---|
| Cover composition | (parts by weight) |
| Hi-milan17O6 *3 | 100 |
| Titanium dioxide | 2 |

*3: Hi-milan 1706 (trade name), ethylene-methacrylic acid copolymer ionomer resin obtained by neutralizing with zinc ion, manufactured by Mitsui Du Pont Polychemical Co., Ltd.

(Surface treatment)

The following surface treatments were performed on the resulting golf ball bodies.

(a) Blast treatment: Silica sand was blown to the golf ball body at a pressure of 0.39 MPa for 3 minutes with rotating the golf ball body, and the golf ball body was washed for 5 minutes using a nylon blush with water.

(b) Barrel grinding treatment: After the golf ball body and abrasive stone were placed in a barrel, the golf ball body was ground by rotating the barrel, and the golf ball body was washed for 5 minutes using a nylon blush with water.

(c) Flaming treatment: The surface of the golf ball body was treated by blowing flame thereto at 800° C. for 0.1 seconds.

(d) Chlorine treatment: The golf ball body was immersed in aqueous solution containing 0.05% of active chlorine at 25° C. for 25 minutes.

### Examples 1 to 11 and Comparative 1 to 15

(Coating of paint)

The paint composition having the formulation shown in Table 3 was prepared. The paint was coated on the pretreated golf ball body by air gun coating to the kind of paint and number of paint layer shown in Tables 4 to 7, and dried and cured at 40° C. for 480 minutes to obtain a coated golf ball. The (U₁+U₂) and (E₁+E₂) shown in Comparative Examples 4, 5 and 8 of Table 4 and 5 mean that the paint U₁ (E₁) is coated as the first paint layer, and then the paint U₂ (E₂) is coated on the first paint layer as the second paint layer. With respect to the resulting coated golf ball, the adhesion strength and maximum difference of thickness of the paint layer were measured or evaluated, an the results are shown in Table 4 to 7. The test methods are described later.

TABLE 3

| | Urethane paint | | Epoxy paint | |
|---|---|---|---|---|
| Paint composition | U₁ | U₂ | E₁ | E₂ |
| Urethane resin *4 | 100 | 100 | — | — |
| Epoxy resin *5 | — | — | 100 | 100 |
| Photostabilizer *6 | 0.2 | — | 0.2 | — |
| UV absorber *7 | 0.1 | — | 0.1 | — |
| Antioxidant *8 | 0.1 | — | 0.1 | — |
| fluorescent | 0.2 | 0.2 | 0.2 | 0.2 |
| brightener *9 | | | | |
| *4: Polyester resin (acid value = 6, hydroxyl number = 120, molecular weight (GPC) Mw = 4800, Mn = 2000) was synthesized by heating a mixture consisted of 30% of neopentyl alcohol, 14% of triethylene glycol, 5% of tris-2-hydroxyethyl isocyanurate, 47% of adipic acid and 4% of tetrahydrophthalic acid at 200 to 250° C. for 4 to 5 hours to esterify. The polyester resin was dissolved in the mixture solvent of methyl isobutyl ketone/xylene = 50/50 to prepare base resin varnis# | | | | |
| h having a nonvolatile content of 80%. To 100 parts by weight of the base resin varnish, 82 parts by weight of Vernock DN-950 (trade name, adduct of hexamethylene diisocyanate with trimethylolpropane, commercially available from Dainippon Ink & Chemicals Inc., content of NCO = 12.0%, nonvolatile content = 75%), 0.005 parts by weight of dibutyltin dilaurate and 222 parts by weight of thinner (the mixture of 30 parts by weight of toluene, 40 parts by weight of ethyl acetate and 40 parts by weight# | | | | |
| of methyl isobutyl ketone) were added to mix, and the thinner was further added to the mixture to obtain urethane resin having a nonvolatile content of 35%. | | | | |

*5: Epoxy resin, consisted of diglycidyl ether of bisphenol A-based main component and polyamide-based curing agent, commercially available from Shinto Paint Co., Ltd. under the trade name of “750LE”
*6: Light stabilizer, commercially available from Sankyo Co., Ltd. under the trade name of “Sanol LS770”
*7: Ultraviolet absorber, commercially available from Ciba Geigy AG under the trade name of “Tinuvin 900”
*8: Antioxidant, commercially available from Ciba Geigy AG under the trade name of “Irganox 245”
*9: Fluorescent brightener, commercially available from Ciba Geigy AG under the trade name of “Ubitex OB”

solvent of methyl isobutyl ketone/xylene=50/50 to prepare base resin varnish having a nonvolatile content of 80%. To 100 parts by weight of the base resin varnish, 82 parts by weight of Vernock DN-950 (trade name, adduct of hexamethylene diisocyanate with trimethylolpropane, commercially available from Dainippon Ink & Chemicals Inc., content of NCO=12.0%, nonvolatile content =75%), 0.005 parts by weight of dibutyltin dilaurate and 222 parts by weight of thinner (the mixture of 30 parts by weight of toluene, 40 parts by weight of ethyl acetate and 40 parts by weight of methyl isobutyl ketone) were added to mix, and the thinner was further added to the mixture to obtain urethane resin having a nonvolatile content of 35%.

*5: Epoxy resin, consisted of diglycidyl ether of bisphenol A-based main component and polyamide-based curing agent, commercially available from Shinto Paint Co., Ltd. under the trade name of “750LE”

*6: Light stabilizer, commercially available from Sankyo Co., Ltd. under the trade name of “Sanol LS770”

*7: Ultraviolet absorber, commercially available from Ciba Geigy AG under the trade name of “Tinuvin 900”

*8: Antioxidant, commercially available from Ciba Geigy AG under the trade name of “Irganox 245”

*9: Fluorescent brightener, commercially available from Ciba Geigy AG under the trade name of “Ubitex OB”

(Test methods)

(1) Adhesion strength 1

After coating the paint, the coated golf ball was left to stand at room temperature for one month, and was immersed in water for 3 days. After the coated golf ball was hit 100 times using a swing robot manufactured by True Temper Co., the appearance of the golf ball was checked by visual observation, and the adhesion strength was determined by evaluating the degree of separation of the paint layer. by visual observation. The evaluation criteria are as follows.

evaluation criteria

∘∘: There is no separation of the paint layer.

∘: The total area of separation of the paint layer is smaller than 0.2 cm².

Δ: The total area of separation of the paint layer is within the range of 0.2 to 0.5 cm².

x: The total area of separation of the paint layer is larger than 0.5 cm².

(2) Adhesion strength 2

The adhesion strength 2 was determined as described in the adhesion strength 1 except that after coating the paint, the coated golf ball was left to stand at room temperature for 4 months.

(3) Maximum difference of thickness

After coating the paint, the coated golf ball was left to stand at room temperature for one day, and the coated golf ball was cut into two equal parts. The thickness of the paint layer was measured in section at 6 measuring points, which are placed at equal intervals. The maximum difference of the thickness of the paint layer was determined by calculating the difference between the maximum thickness and minimum thickness.

(Test Results)

TABLE 4-a

| | Example No. | | | | |
|---|---|---|---|---|---|
| Test item | 1 | 2 | 3 | 4 | 5 |
| Golf ball | I | I | I | I | I |
| Surface treatment | b | b | b | b | b |
| Time from molding | 3 | 24 | 48 | 72 | 48 |
| to coating (hour) | | | | | |
| Paint | U₁ | U₁ | U₁ | U₁ | E₁ |
| Number of painting | 1 | 1 | 1 | 1 | 1 |
| Adhesion strength (1) | ∘∘ | ∘∘ | ∘∘ | ∘∘ | ∘∘ |
| Adhesion strength (2) | ∘∘ | ∘∘ | ∘∘ | ∘ | ∘ |
| Maximum difference of | 2 | 3 | 2 | 2 | 3 |
| thickness (μm) | | | | | |

TABLE 4-b

| | Comparative Example No. | | | | |
|---|---|---|---|---|---|
| Test item | 1 | 2 | 3 | 4 | 5 |
| Golf ball | I | I | I | I | I |
| Surface treatment | b | b | b | b | b |
| Time from molding | 96 | 120 | 120 | 48 | 48 |
| to coating (hour) | | | | | |
| Paint | U₁ | U₁ | E₁ | U₁ + U₂ | E₁ + E₂ |
| Number of painting | 1 | 1 | 1 | 2 | 2 |
| Adhesion strength (1) | ∘ | Δ | x | ∘ | ∘ |
| Adhesion strength (2) | x | x | x | x | x |
| Maximum difference of | 3 | 3 | 3 | 3 | 3 |
| thickness (μm) | | | | | |

TABLE 5

| | | | Comparative | | |
|---|---|---|---|---|---|
| | Example No. | | Example No. | | |
| Test item | 6 | 7 | 6 | 7 | 8 |
| Golf ball | II | I | II | I | I |
| Surface treatment | b | b | b | b | b |
| Time from molding | 48 | 48 | 120 | 120 | 48 |
| to coating (hour) | | | | | |
| Paint | U₁ | E₁ | U₁ | E₁ | U₁ + U₂ |
| Number of painting | 1 | 1 | 1 | 1 | 2 |
| Adhesion strength (1) | ∘∘ | ∘∘ | Δ | Δ | ∘ |
| Adhesion strength (2) | ∘∘ | ∘ | x | x | Δ |
| Maximum difference | 3 | 3 | 3 | 3 | 3 |
| of thickness (μm) | | | | | |

TABLE 6

| | Example No. | | Comparative Example No. | | | |
|---|---|---|---|---|---|---|
| Test item | 8 | 9 | 9 | 10 | 11 | 12 |
| Golf ball | I | I | I | I | I | I |
| Surface treatment | a | c | a | c | d | d |
| Time from molding to | 48 | 48 | 120 | 120 | 48 | 120 |
| coating (hour) | | | | | | |
| Paint | U₁ | U₁ | U₁ | U₁ | U₁ | U₁ |
| Number of painting | 1 | 1 | 1 | 1 | 1 | 1 |
| Adhesion strength (1) | ∘∘ | ∘∘ | Δ | x | ∘ | x |
| Adhesion strength (2) | ∘∘ | ∘∘ | x | x | ∘ | x |
| Maximum difference | 2 | 3 | 3 | 3 | 11 | 10 |
| of thickness (μm) | | | | | | |

TABLE 7

| | | | | Comparative | | |
|---|---|---|---|---|---|---|
| | Example No. | | | Example No. | | |
| Test item | 10 | 11 | 13 | 14 | 15 | 16 |
| Golf ball | II | II | II | II | II | II |
| Surface treatment | a | c | a | c | d | d |
| Time from molding to | 48 | 48 | 120 | 120 | 48 | 120 |
| coating (hour) | | | | | | |
| Paint | U₁ | U₁ | U₁ | U₁ | U₁ | U₁ |
| Number of painting | 1 | 1 | 1 | 1 | 1 | 1 |
| Adhesion strength (1) | ∘∘ | ∘∘ | Δ | Δ | ∘ | Δ |
| Adhesion strength (2) | ∘∘ | ∘∘ | x | x | ∘ | x |
| Maximum difference | 3 | 3 | 3 | 3 | 9 | 12 |
| of thickness (μm) | | | | | | |

As is apparent from the results of Tables 4 to 7, in the coated golf balls of Examples 1 to 11, when compared with those of the golf balls of Comparative Examples 1 to 15, the maximum difference of the thickness of the paint layer is small and the thickness of the paint layer is uniform; the adhesion strength is excellent. In Table 4, the golf ball body is two-piece golf ball and the surface treatment is barrel grinding treatment. In Table 5, the golf ball body is one-piece golf ball and the surface treatment is barrel grinding treatment. In Table 6, the golf ball body is two-piece golf ball and the surface treatment is blast treatment, flaming treatment or chlorine treatment. In Table 7, the golf ball body is one-piece golf ball and the surface treatment is blast treatment, flaming treatment or chlorine treatment.

(Table 4)

On the other hand, in the coated golf balls of Comparative Examples 1 and 2, of which the time from molding to coating is longer than the golf balls of Examples 1 to 4, the maximum difference of the thickness of the paint layer is large and the adhesion strength is poor. In the coated golf ball of Comparative Example 3, of which the time from molding to coating is longer than the golf ball of Example 5, the adhesion strength is poor. In the coated golf balls of Comparative Examples 4 and 5, the paint is coated to two layers, and the adhesion strength is poor.

(Table 5)

In the coated golf ball of Comparative Example 6, of which the time from molding to coating is longer than the golf ball of Example 6, the adhesion strength is poor. In the coated golf ball of Comparative Example 7, of which the time from molding to coating is longer than the golf ball of Example 7, the adhesion strength is poor. In the coated golf ball of Comparative Example 8, the paint, which is the same as that of the coated golf ball of Example 7, is coated to two layers, and the adhesion strength is poor.

(Table 6)

In the coated golf ball of Comparative Example 9, of which the time from molding to coating is longer than the golf ball of Example 8, the maximum difference of the thickness of the paint layer is large and the adhesion strength is poor. In the coated golf ball of Comparative Example 10, of which the time from molding to coating is longer than the golf ball of Example 9, the adhesion strength is poor. In the coated golf ball of Comparative Example 11, of which the time from molding to coating is within the scope of the present invention, but the surface treatment is the chlorine treatment, the maximum difference of the thickness of the paint layer is very large. In the coated golf ball of Comparative Example 12, of which the time from molding to coating is longer than the golf ball of Comparative Example 11, the maximum difference of the thickness of the paint layer is very large and the adhesion strength is poor.

(Table 7)

In the coated golf ball of Comparative Example 13, of which the time from molding to coating is longer than the golf ball of Example 10, the adhesion strength is poor. In the coated golf ball of Comparative Example 14, of which the time from molding to coating is longer than the golf ball of Example 11, the adhesion strength is poor. In the coated golf ball of Comparative Example 15, of which the time from molding to coating is within the scope of the present invention, but the surface treatment is the chlorine treatment, the maximum difference of the thickness of the paint layer is very large. In the coated golf ball of Comparative Example 16, of which the time from molding to coating is longer than the golf ball of Comparative Example 15, the maximum difference of the thickness of the paint layer is very large and the adhesion strength is poor.

As is apparent from the above results, there is a case of accomplishing the technical effects as good as the barrel grinding treatment in the blast treatment, flaming treatment and chlorine treatment as a surface treatment. It is difficult in the chlorine treatment to obtain uniformity of wettability throughout the surface of the golf ball body, and the thickness difference of the paint layer is large and the thickness is not uniform. In addition, the separation of the paint layer occurs at a portion having small thickness, and the adhesion strength is poor when compared with the other portion. In view of the cost of apparatus, the barrel grinding is the most excellent, and the blast treatment, flaming treatment and chlorine treatment are poor in order. In the chlorine treatment, since a toxic substance is used, there are problem with regard to safety and influence to environment.

What is claimed is:

1. A method of making a coated golf ball comprising
a golf ball body, of which the surface portion is formed from resin composition or rubber composition, and
a paint layer formed on the golf ball body,
wherein the paint is coated within 72 hours after molding the golf ball body in a mold.

2. The method according to claim 1, wherein further comprising a step of performing a pretreatment of the surface of the golf ball body for coating a paint by at least one treatment selected from the group consisting of grinding or blasting treatment, washing and flaming treatment, before coating the paint.

3. The method according to claim 2, wherein the step of performing a pretreatment of the surface of the golf ball body is performed by the grinding or blasting treatment, followed by the washing treatment.

4. The method according to claim 1, wherein the paint is urethane-based paint or epoxy-based paint.
